(19) United States
(12) Patent Application Publication
(10) Pub. No.: US 2023/0021702 A1
(43) Pub. Date: Jan. 26, 2023

(54) SYSTEM AND METHOD FOR STORING AND RETRIEVING A TRUSTED SECURE DATA OBJECT BY AND AMONG MULTIPLE PARTIES

(71) Applicant: Halcyon Still Water, LLC, Red Bank, NJ (US)

(72) Inventors: Conway K. Donaldson, Fair Haven, NJ (US); James W. McGowan, Flemington, NJ (US); Elizabeth A. Boonin, East Setauket, NY (US)

(21) Appl. No.: 17/874,089

(22) Filed: Jul. 26, 2022

Related U.S. Application Data
(60) Provisional application No. 63/225,800, filed on Jul. 26, 2021.

(51) Int. Cl. H04L 9/32; G06Q 40/00

(52) U.S. Cl. CPC H04L 9/3213; H04L 9/3247; G06Q 40/123

(57) ABSTRACT

The system may perform a method for controlling access to a secure data object. The secure data object may be a tax return. The method may implement a distributed ledger and tokens. A tax preparer or an owner of a tax return may put the tax return into a distributed ledger and securely associate the tax return with a token. By sharing the token with authorized third parties, the tax preparer or owner of the tax return may allow others to access the tax return. By retrieving the tax return from the distributed ledger with the token, rather than receiving the tax return directly from an owner of the tax return, the authorized third parties may be assured of the authenticity of the tax return that they are accessing with the token.

### CROSS-REFERENCE TO RELATED APPLICATIONS

This disclosure claims priority to, and the benefits of, U.S. Ser. No. 63/225,800 filed on Jul. 26, 2021, and entitled “SYSTEM AND METHOD FOR STORING TAX RETURN DATA ON A TRUSTED TAX RETURN,” which is hereby incorporated by reference in its entirety for all purposes.

### TECHNICAL FIELD

This disclosure generally relates to storing and retrieving secure data objects, and more particularly, to a system and method for storing and retrieving trusted secure data objects by and among multiple parties.

### BACKGROUND

An owner or preparer of a secure data object (such as an electronic tax return) often need to share that secure data object with others. However, the recipients of the object typically also desire to confirm the authenticity of the shared secure data object. Prior efforts have been limited to retrieving of a secure data object from a trusted institution, such as a government taxing authority or other regulator. However, such efforts require the cooperation of a third-party institution (e.g., the government taxing authority) are cumbersome, time-consuming and require participation of the owner of the secure data object. Thus, there remains a need for a distributed system that can provide trust and/or verification of the authenticity of the shared secure data object without needing repeated intervention of the owner, nor cooperation of third-party institutions.

### SUMMARY

In various embodiments, the system controls access to a secure data object. The method may include receiving, at a secure data object (SDO) access manager, a secure data obj ect from a first remote processor controlled by a first remote party. The method may include adding, by the SDO access manager, the secure data object to a distributed ledger to create a first ledger entry. The method may include generating, by the SDO access manager, a first token representing ownership of the first ledger entry. The method may include assigning, by the SDO access manager, the first token to a first owner identified in the secure data obj ect. The method may include recording, by the SDO access manager, the assignment of the first token to the first owner in a blockchain.

The method may include further aspects. For instance, the method may include recording, by the blockchain, an instruction from the first owner processor controlled by the first owner to assign the first token to a first third-party in the blockchain. The method may include receiving by the third-party processor, the first token. The method may include transmitting, by the third-party processor, the first token, to the distributed ledger. The method may include accessing, by the third-party processor, the first ledger entry of the ledger associated with the first token. The method may include retrieving, by the third-party processor, the first secure data object from the distributed ledger, the first secure data object being associated with the first token.

In various embodiments, the method may include transmitting the token to a third-party processor in response to an instruction from a first owner processor controlled by the first owner to provide the first token to the third-party. Moreover, in various embodiments, the first ledger entry of the distributed ledger is a data entry indicating a correspondence of the first token to the first secure data object, wherein the first secure data object is associated with the first owner. The third-party processor may be a computing system of a certified public accountant. The third-party processor may be a computing system of a government taxing authority. The secure data object may be a tax return. The distributed ledger may be the blockchain.

### BRIEF DESCRIPTION OF THE DRAWINGS

The accompanying drawings, wherein like numerals depict like elements, illustrate exemplary embodiments of the present disclosure, and together with the description, serve to explain the principles of the disclosure. In the drawings:

FIG. 1 shows a system for controlling access to a secure data object, in accordance with various embodiments; and

FIG. 2 illustrates a flowchart showing aspects of a method for controlling access to the secure data object, in accordance with various embodiments.

### DETAILED DESCRIPTION

A system and method are described for controlling access to a secure data object. The secure data object may be a tax return. The method may implement a distributed ledger and tokens. In various embodiments, a tax preparer or an owner of a tax return may put the tax return into a distributed ledger and securely associate the tax return with a token. By sharing the token with authorized third parties, the tax preparer or owner of the tax return may allow others to access the tax return. By retrieving the tax return from the distributed ledger with the token (rather than receiving the tax return directly from an owner of the tax return), the authorized third parties may be assured of the authenticity of the tax return that they are accessing with the token.

Stated another way, the system creates and maintains a trusted ledger of historical, verified tax returns. The system may have many practical use cases. For instance, in a case of a mortgage application, a lender typically requires tax returns from multiple prior years for income verification. There are currently two trusted methods of collecting the tax returns, both establishing a chain of trust that significantly reduces fraud. First, a party may obtain tax returns from the IRS by filing a 4506-C, IVES Request for Transcript of Tax Return (“4506-C”). Second, a party may obtain previously filed tax returns from a licensed Certified Public Accountant (“CPA”).

These methods are both cumbersome and require third parties to cooperate. This system provides a system and method where an intermediary computer system requests the tax return and acts as a trusted authority to provide the tax return upon request, without breaking the chain of trust. The intermediary stores the tax return on a secure ledger in such a way as to ensure that future requests for tax returns can be verified, without the need to re-establish trust through the 4506-C or CPA. This eliminates a need for ongoing third-party cooperation. Moreover, that ledger may be a blockchain, and, optionally, that blockchain ledger can be used to create a cryptocurrency. Furthermore, while a discussion will refer to tax returns, one may appreciate that a tax return is merely an exemplary type of potential secure data object that may be handled by the system and method.

In one brief example use case, a tax return is the secure data object. A tax return may be generated by the system or any other system. The system determines whether the tax return was generated by a CPA or not. The system may determine if any data or identifier associated with a CPA is on the tax return. For example, the system may determine if the CPA's PTIN, which is typically located in the “Paid Preparer Use Only” section of the 1040. The PTIN is the IRS's way of identifying the CPA. If the tax return was not generated by an appropriately licensed CPA, the system automatically sends a 4056-C for an e-signature to the tax filer, and then files the 4056-C with the IRS to obtain the tax return from the IRS. If the tax return was generated by an appropriately licensed CPA, the tax return is collected or electronically transmitted from the CPA to the system. The tax return is added to a blockchain ledger by adding the tax return PDF as a block on the blockchain. In particular, the system encodes the PDF cryptographically (i.e., so no one can read the PDF unless they have the key to decode it) and creates a block on the blockchain. A token is generated representing ownership of that ledger entry. In particular, when a block is added to the blockchain, a hash of the encoded PDF (object) is generated, which is referred to as a token. A token is a digital asset that is stored securely on a blockchain (see, for instance, https://blockheadtechnologies.com/what-is-a-blockchain-token-is-it-just-cryptocurrency/). Bitcoin is an example token. The system receives back the token from the blockchain, wherein the token uniquely represents that encoded PDF at that point in time. The token is granted to the person or entity listed on the tax return (the “taxpayer”), or an agent, for the purposes of owning permission to access the tax return. That is, the agent receives the token for allowing access to the tax return. Following this, the process repeats when a new tax return is ready. Eventually, a taxpayer collects a set of tokens, one for each return. Each token is unique. A token is publicly visible, and ownership is tracked on the blockchain. A password is kept secret, so once the token shared, the password must be changed for use of the token to be revoked. With a blockchain token, use of the token automatically causes the blockchain record to be updated to include the use of the token. If a taxpayer grants use of the blockchain data to a CPA (e.g., the system provides the token to the CPA), and the CPA accesses the blockchain data, the token can be programmed to automatically revert ownership to the taxpayer. In particular, this process is how blockchains can be made to work with smart currencies. The system may grant access to a taxpayer's data, and immediately upon the CPA using the taxpayer data, a smart contract then grants a new token to the encoded PDF, and assigns that new token to the taxpayer. This way, the system guarantees the CPA has a single use of the data, and then the taxpayer goes back to owning the data.

In another exemplary use case, a taxpayer (“Applicant”) applies for a loan, or for some reason needs to provide a trusted copy of a tax return. The Applicant provides to an agent the token (without the need for a password) for purposes of retrieving a tax return. The token may be provided through an email, text or other portal. The agent uses the token to retrieve the tax return from the ledger. The token may expire after use by, for example, the smart-contract invalidating the token. The smart contract may simply create a new transaction on the blockchain for that same asset, and that new token would be returned to the original user (e.g., through email or text).

Any of the systems described herein may include a separate hardware device including a processor, a non-volatile memory, a database, and a display screen. The processor may be configured to execute instructions stored on the non-volatile memory and display information on the display screen. The devices described herein may be a part of a single device having multiple software devices executed by a processor and a non-volatile memory. The systems described herein are special purpose machines configured to perform their respective tasks described herein.

The system may allow users to access data (e.g., tax records, tax forms, completed tax returns, etc), and receive updated data in real time from other users. The system may store the data (e.g., in a standardized format) in a plurality of storage devices, provide remote access over a network so that users may update the data in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system allows remote users to share data in real time in a standardized format, regardless of the format (e.g. non-standardized) that the information was input by the user. The system may also include a filtering tool that is remote from the end user and provides customizable filtering features to each end user. The filtering tool may provide customizable filtering by filtering access to the data. The filtering tool may identify data or accounts that communicate with the server and may associate a request for content with the individual account. The system may include a filter on a local computer and a filter on a server.

The unstandardized formats may include, for example, unstructured, free-form text, key words spotted on forms (e.g., federal forms or tax filing forms), or any other format not explicitly intended to represent the tax information in a standardized form. Standardized forms may include, for example, IRS forms, JSON, YAML, XML or other common data formats configured to explicitly list tax information. For instance, the system could detect “$743.32” and “$512.89”, respectively, on a pair of invoices, each near the text “total”, and generate for demonstrative purposes only {“deductions”: [743.32, 512.89]}. Data can be filtered by the client, type of form, or relevance to a tax return. For instance, medical expenses may be filtered if they do not exceed the minimum threshold before the medical expenses are eligible as a deductible expense.

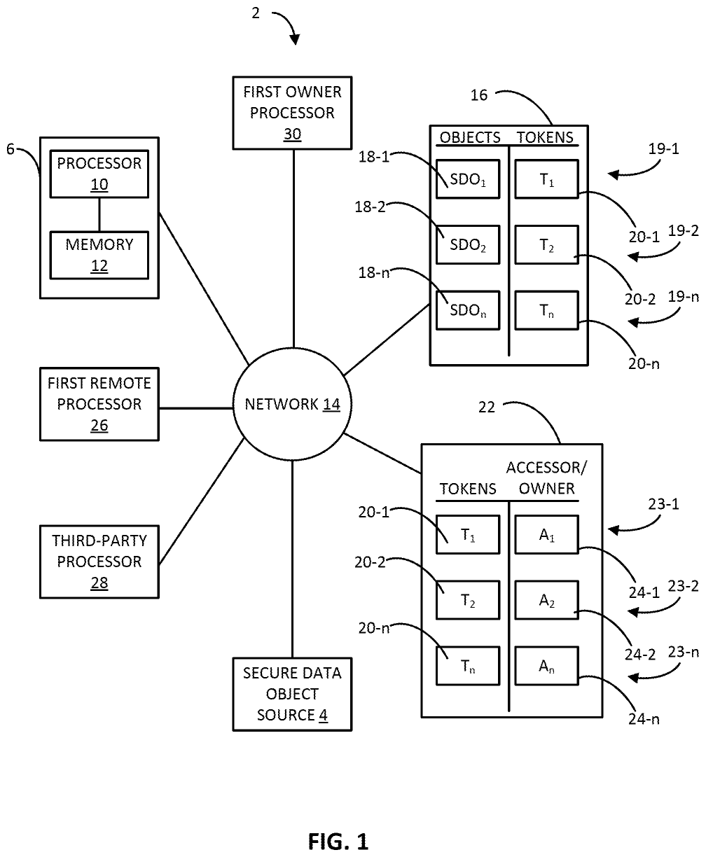

In various embodiments, with respect to FIG. 1, an exemplary system 2 controls access to a secure data object. The system may include a secure data object (SDO) access manager 6. The SDO access manager 6 may be a computer, server, distributed computing system, or other electronic device having a processor 10 and a memory 12. The processor 10 may be any computer processor and the memory 12 may be any memory capable of storing data for use by the processor 10. The SDO access manager 6 is configured to transmit and receive data and instructions among other aspects of the system and control access to the secure data object such as via the issuance, storage, retrieval, and revocation of tokens.

The system may have a secure data object (SDO) source 4. An SDO source 4 may be a computing system of a certified public accountancy or may be a computer system of a government regulatory authority, or another computing system that initially provides a secure data obj ect.

The system may include a first owner processor 30. The first owner processor 30 comprises a computing system operated by an owner of a secure data object. The first owner processor 30 is configured to provide various instructions regarding the secure data object.

The system may include a third-party processor 28. A third-party processor 28 comprises a computing system operated by a third-party that seeks to gain access to the secure data obj ect.

The system may include a distributed ledger 16. The distributed ledger may comprise an electronic database and/or set of database entries. The distributed ledger may include a plurality of ledger entries, such as a first ledger entry 19-1, a second ledger entry 19-2, and any number ‘n’ of ledger entries, such as a n-th ledger entry 19-n. Each ledger entry may include a secure data object and a token. In various instances, the ledger entry includes data representative of a secure data object and/or representative of a token. The ledger entry may include (or may include data representative of) a first secure data object 18-1 and an associated first token 20-1, a second secure data object 18-2 and an associated second token 20-2, and any number ‘n of secure data objects and associated tokens such as an n-th secure data object 18-n and an associated n-th token 20-n.

Each of the tokens may comprise a unique numerical and/or mathematical representation that is associated with a unique secure data object. A relationship between a secure data object and a token may be analogized as relationship between a building and a street address. The token is a unique identifier of the SDO.

The system may include a blockchain 22. A blockchain 22 may include records of tokens and associated ownership or assigned access rights of each token. An owner is an individual or entity associated with data inside a secure data object referenced by the token. An accessor is a third-party who the owner has granted rights to access the secure data object referenced by the token. The blockchain may record association of owners and/or accessors with tokens. For instance, the blockchain 22 may include a first record 23-1 associating a first token 20-1 with a first owner/accessor 24-1. The blockchain 22 may include a second record 23-2 associating a second token 20-2 with a second owner/accessor 24-2. The blockchain 22 may include any number ‘n’ of records associating tokens with owners/accessors, such as a n-th record 23-n associating a n-th token 20-n with a n-th owner/accessor 24-n.

Each aspect of the system may be connected to a network 14. In this manner, the system 2 may be distributed and/or located in remote locations but interconnected by the network 14. The network 14 may comprise the internet, or an intranet, or a direct connection, or any connectivity.

The processor 10 of the SDO access manager 6 and the memory 12 of the SDO access manager 6 may implement various methods. In an exemplary case, FIG. 1 shows a system 2 for controlling access to a secure data object by a secure data object access manager. The system 2 has a non-transitory computer-readable memory 12 configured to store a set of instructions. The system 2 has one or more processor 10 configured to perform the set of instructions. The set of instructions may include receiving, at the secure data object (SDO) access manager 6, a secure data object from a first remote processor controlled by a first remote party (e.g., a secure data object source 4). The instructions may include adding, by the SDO access manager 6, the secure data object to a distributed ledger 16 to create a first ledger entry 19-1. The method may include generating, by the SDO access manager 6, a first token 20-1 representing ownership of the first ledger entry 19-1. The instructions may include assigning, by the SDO access manager 6, the first token 20-1 to a first owner 24-1 identified in the secure data object 18-1. The instructions may include recording, by the SDO access manager 6, the assignment of the first token 20-1 to the first owner 24-1 in a blockchain 22.

The set of instructions may also include recording, by the blockchain 22, an instruction from the first owner processor 30 controlled by the first owner to assign the first token 20-1 to a first third-party having a third-party processor 28 in the blockchain 22. The instructions may include receiving by the third-party processor 28, the first token 20-1. The instructions may include transmitting, by the third-party processor 28, the first token 20-1, to the distributed ledger 16. The instructions may include accessing, by the third-party processor 26, the first ledger entry 19-1 of the distributed ledger 16 associated with the first token 20-1 and retrieving, by the third-party processor 28, the first secure data object 18-1 from the distributed ledger 16, the first secure data object 18-1 being associated with the first token 20-1.

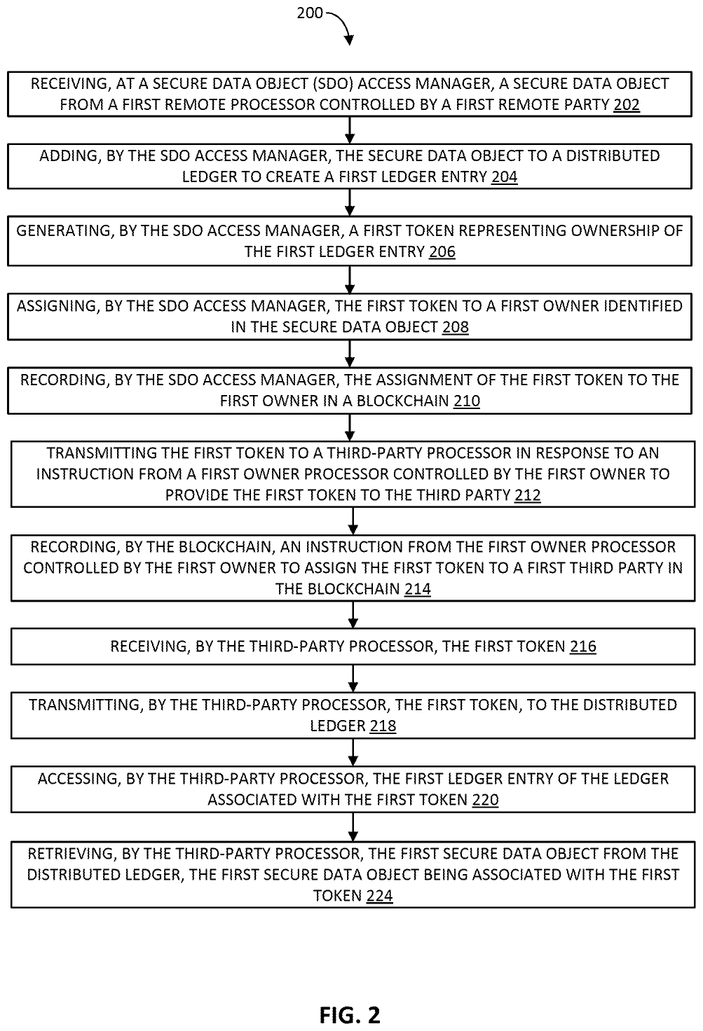

With respect to FIG. 2, in various embodiments, the method 200 may control access to a secure data object. The method may include receiving, at a secure data object (SDO) access manager, a secure data object from a first remote processor controlled by a first remote party (block 202). The method may include adding, by the SDO access manager, the secure data object to a distributed ledger to create a first ledger entry (block 204). The method may include generating, by the SDO access manager, a first token representing ownership of the first ledger entry (block 206). The method may include assigning, by the SDO access manager, the first token to a first owner identified in the secure data object (block 208). The method may include recording, by the SDO access manager, the assignment of the first token to the first owner in a blockchain (block 210).

The method may include other aspects. The method may include transmitting the token to a third-party processor in response to an instruction from a first owner processor controlled by the first owner to provide the first token to the third-party (block 212). The method may include recording, by the blockchain, an instruction from the first owner processor controlled by the first owner to assign the first token to a first third-party in the blockchain (block 214). The method may include receiving by the third-party processor, the first token (block 216). The method may include transmitting, by the third-party processor, the first token, to the distributed ledger (block 218). The method may include accessing, by the third-party processor, the first ledger entry of the ledger associated with the first token (block 220) and retrieving, by the third-party processor, the first secure data object from the distributed ledger, the first secure data object being associated with the first token (block 222).

Notably, the first ledger entry of the distributed ledger may be a data entry indicating a correspondence of the first token to the first secure data object. The first secure data object is associated with the first owner.

The third-party processor may be a computing system of a Certified Public Accountant. Similarly, the third-party processor may be a computing system of a government taxing authority. The secure data object may be a tax return.

Finally, a non-transitory computer-readable medium is provided. The medium comprises computer readable instructions, which when executed by a processor, cause the processor to perform a method including operations for controlling access to a secure data object, the method may comprise aspects discussed herein above.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each, and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Terms and phrases similar to “associate” and/or “associating” may include tagging, flagging, correlating, using a look-up table or any other method or system for indicating or creating a relationship between elements, such as, for example, (i) a mandatory criteria and/or preferred criteria and (ii) a target criteria. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method known in the art.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC °, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQTM (formerly MQSeries) by IBM °, Inc. (Armonk, N.Y.) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMIEPOD® system of the APPLE® company, and/or similar digital assistant technologies. The ALEXA® system, GOOGLE HOME® system, and ^{HOMEPOD}® system, may each provide cloud-based voice activation services that can assist with tasks, entertainment, general information, and more. All the ALEXA devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME ®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, crossover bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, ProX-Y based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third-party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set, e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a ^{HADOOP}® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER Fabric 1.0 based platform, the duration is driven by the specific consensus algorithm that is chosen and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

Any communication, transmission, and/or channel discussed herein may include any system or method for delivering content (e.g., data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST^{TM}, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT , SNAPCHAT®, WHATSAPP®, FLICKR®, VK®, QZONE®, WECHAT , and the like. Examples of affiliate or partner websites include AMERICAN EXPRESS®, GROUPON®, LIVINGSOCIAL , and the like. Moreover, examples of mobile device communications include texting, email, and mobile applications for smartphones.

We claim:

1. A method comprising:
receiving, by a secure data object (SDO) access manager, a secure data obj ect from a first remote processor controlled by a first remote party;
adding, by the SDO access manager, the secure data object to a distributed ledger to create a first ledger entry;
generating, by the SDO access manager, a first token representing ownership of the first ledger entry;
assigning, by the SDO access manager, the first token to a first owner identified in the secure data object; and
recording, by the SDO access manager, the assignment of the first token to the first owner in a blockchain.

2. The method of claim 1, further comprising transmitting, by the SDO access manager, the first token to a third-party processor, in response to an instruction from a first owner processor controlled by the first owner to provide the first token to the third-party.

3. The method of claim 1, wherein the first ledger entry of the distributed ledger comprises a data entry indicating a correspondence of the first token to the first secure data object, wherein the first secure data object is associated with the first owner.

4. The method of claim 1, wherein the blockchain records an instruction from a first owner processor controlled by the first owner to assign the first token to a third-party processor in the blockchain.

5. The method of claim 4, wherein the third-party processor
receives the first token;
transmits the first token to the distributed ledger;
accesses the first ledger entry of the ledger associated with the first token; and
retrieves the first secure data object from the distributed ledger, the first secure data object being associated with the first token.

6. The method of claim 5, wherein the third-party processor is a computing system of a certified public accountant.

7. The method of claim 5, wherein the third-party processor is a computing system of a government taxing authority.

8. The method of claim 5, wherein the secure data object is a tax return.

9. The method of claim 4, wherein the distributed ledger is the blockchain.

10. An article of manufacture including a non-transitory, tangible computer readable storage medium having instructions stored thereon that, in response to execution by a secure data object (SDO) access manager, cause the SDO access manager to perform operations comprising:
receiving, by the SDO access manager, a secure data object from a first remote processor controlled by a first remote party;
adding, by the SDO access manager, the secure data obj ect to a distributed ledger to create a first ledger entry;
generating, by the SDO access manager, a first token representing ownership of the first ledger entry;
assigning, by the SDO access manager, the first token to a first owner identified in the secure data object; and
recording, by the SDO access manager, the assignment of the first token to the first owner in a blockchain.

11. The non-transitory computer-readable medium according to claim 10, further comprising transmitting, by the SDO access manager, the first token to a third-party processor in response to an instruction from a first owner processor controlled by the first owner to provide the first token to the third-party.

12. The non-transitory computer-readable medium according to claim 10, wherein the first ledger entry of the distributed ledger comprises a data entry indicating a correspondence of the first token to the first secure data object, wherein the first secure data object is associated with the first owner.

13. The non-transitory computer-readable medium according to claim 10, wherein the blockchain records an instruction from a first owner processor controlled by the first owner to assign the first token to a first third-party processor in the blockchain.

14. The non-transitory computer-readable medium according to claim 13, wherein the third-party processor:
receives the first token;
transmits the first token to the distributed ledger;
accesses the first ledger entry of the ledger associated with the first token; and
retrieves the first secure data object from the distributed ledger, the first secure data object being associated with the first token.

15. The non-transitory computer-readable medium according to claim 14, wherein the third-party processor is a computing system of a certified public accountant.

16. The non-transitory computer-readable medium according to claim 14, wherein the third-party processor is a computing system of a government taxing authority.

17. The non-transitory computer-readable medium according to claim 14, wherein the secure data object is a tax return.

18. The non-transitory computer-readable medium according to claim 13, wherein the distributed ledger is the blockchain.

19. A system comprising:
a secure data object (SDO) access manager having a processor; and
a tangible, non-transitory memory configured to communicate with the processor,
the tangible, non-transitory memory having instructions stored thereon that, in response to execution by the processor, cause the processor to perform operations comprising:
receiving, by the SDO access manager, a secure data object from a first remote processor controlled by a first remote party;
adding, by the SDO access manager, the secure data object to a distributed ledger to create a first ledger entry;
generating, by the SDO access manager, a first token representing ownership of the first ledger entry;
assigning, by the SDO access manager, the first token to a first owner identified in the secure data object; and
recording, by the SDO access manager, the assignment of the first token to the first owner in a blockchain.

20. The system 19, wherein the blockchain records an instruction from a first owner processor controlled by the first owner to assign the first token to a first third-party processor in the blockchain, and wherein the first third-party processor:
receives the first token;
transmits the first token to the distributed ledger;
accesses the first ledger entry of the ledger associated with the first token; and
retrieves the first secure data object from the distributed ledger, the first secure data object being associated with the first token.
